(19) United States
(12) Patent Application Publication
(10) Pub. No.: US 2011/0057977 A1
(43) Pub. Date: Mar. 10, 2011

(54) MEDIUM DETECTING DEVICE, PRINTER HAVING THE SAME AND MEDIUM DETECTING METHOD

(75) Inventor: Yoshimasa Inoue, Shizuoka (JP)

(73) Assignee: TOSHIBA TEC KABUSHIKI KAISHA, Tokyo (JP)

(21) Appl. No.: 12/860,398

(22) Filed: Aug. 20, 2010

(30) Foreign Application Priority Data
Sep. 10, 2009 (JP) 2009-208792

(51) Int. Cl. B41J 29/38

(52) U.S. Cl. 347/16

(57) ABSTRACT

A medium detecting device including a conveying path configured to convey a plurality of mediums therethrough is provided. A plurality of sensors configured to detect at least one of the plurality of mediums disposed in a conveying direction of the conveying path is also provided. The plurality of sensors is arranged at intervals longer than a minimum length of at least one of the plurality of mediums. A control unit is configured to generate position information of the plurality of mediums based on output from the plurality of sensors, and the relationship between the sensors.

### CROSS-REFERENCE TO RELATED APPLICATIONS

This application is based upon and claims the benefit of priority from Japanese Patent Application No. 2009-208792, filed on Sep. 10, 2009, the entire contents of which is incorporated herein by reference.

### FIELD

Embodiments described herein relate to a paper sheet detecting device and printer for detecting the presence and position of paper sheets being conveyed therethrough.

### BACKGROUND

A printer for printing paper sheets, such as passbooks, accepts a passbook inserted in an insert hole and conveys it to a dot head. The dot head prints data in empty columns of the passbook. The printed passbook is conveyed to and discharged out of the insert hole. A plurality of conveying rollers for conveying the passbook and a plurality of sensors for optically detecting the presence and position of the passbook are disposed on a conveying path extending from the insert hole to the nearby dot head.

The sensors are disposed at intervals less than the minimum length of the passbook to allow the presence and position of the passbook to be detected at all times.

In the related art, there have been proposed various techniques including sensors for optically detecting paper sheets such as passbooks and the like.

### BRIEF DESCRIPTION OF THE DRAWINGS

FIG. 1 illustrate the configuration of a printer according to an embodiment.

FIG. 2 is a block diagram illustrating a control circuit according to an embodiment.

FIG. 3 is a flowchart for explaining an operation according to an embodiment.

FIG. 4 illustrates a state where a passbook is being conveyed forward and does not yet cover both sensors, according to an embodiment.

FIG. 5 illustrates a state where the passbook covers a front sensor, subsequent to FIG. 4.

FIG. 6 illustrates a state where the passbook is moved between both sensors, subsequent to FIG. 5.

FIG. 7 illustrates a state where the passbook covers a rear sensor, subsequent to FIG. 6.

FIG. 8 illustrates a state where the passbook passes through positions of both sensors, subsequent to FIG. 7.

FIG. 9 illustrates a state where the passbook is conveyed in backward and covers the rear sensor.

FIG. 10 illustrates a state where the passbook is moved between both sensors, subsequent to FIG. 9.

FIG. 11 illustrates a state where the passbook covers the front sensor, subsequent to FIG. 10.

FIG. 12 illustrates a state where the passbook passes through the positions of both sensors, subsequent to FIG. 11.

### DETAILED DESCRIPTION

If the sensors are disposed at intervals less than the minimum length of the passbook, the number of sensors becomes large, which may increase production costs.

According to one embodiment, a medium detecting device is provided. The medium detecting device comprises a conveying path configured to convey a plurality of mediums therethrough and a plurality of sensors configured to detect at least one of the plurality of mediums disposed in a conveying direction of the conveying path. The plurality of sensors is arranged at intervals longer than a minimum length of at least one of the plurality of mediums. The medium detecting device also comprises a control unit configured to generate position information of the plurality of mediums based on output from the plurality of sensors, and the relationship between the sensors.

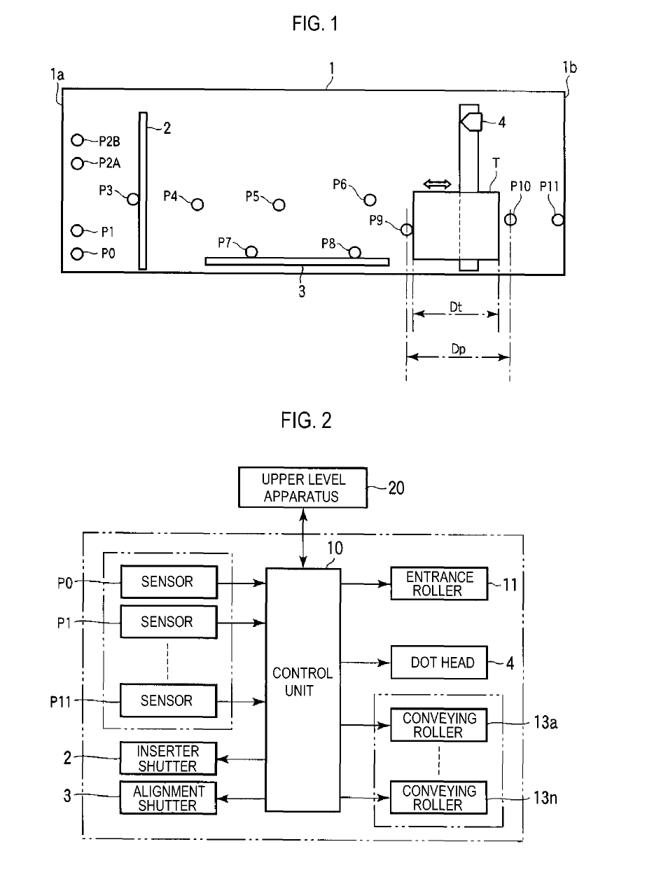

Hereinafter, one embodiment will be described with reference to the drawings. FIG. 1 shows the entire configuration of a printer according to one embodiment. In FIG. 1, reference numeral 1 denotes a conveying path in which a paper sheet such as a passbook T is conveyed forward from the leading end, i.e., a passbook insert hole 1a, to the tailing end 1b of the printer and the passbook T arrived at the tailing end is conveyed backward toward the passbook insert hole 1a.

A switchable inserter shutter 2 is disposed near the passbook insert hole 1a on the conveying path 1 and can be opened and shut. An alignment shutter 3 is disposed in the middle of the conveying path 1. A dot head 4 for performing a dot matrix print for the passbook T is disposed at the side of the tailing end 1b of the conveying path 1. The dot head 4 is movable in a direction perpendicular to the conveying direction of the conveying path 1 and prints character information in empty columns of the passbook T.

A plurality of sensors P0, P1, P2A and P2B for detection of paper sheets is arranged in the passbook insert hole 1a on the conveying path 1. The passbook insert hole 1a may be sized and configured to receive the passbook T. These sensors P0, P1, P2A and P2B optically detect the presence of the passbook T in the passbook insert hole 1a. In addition, a plurality of sensors P3, P4, . . . , P11 for detection of paper sheets is arranged in the conveying path 1 and its conveying direction. These sensors P3, P4, . . . , P11 optically detect the presence and position of the passbook T. The dot head 4 is located between the sensors P9 and P10 of these sensors P3, P4, . . . , P11.

In addition, a gap Dp between at least the sensor P9 (first sensor) and the sensor P10 (second sensor) of the sensors P3, P4, . . . , P11, with the dot head 4 located therebetween, is set to be longer than the minimum length Dt of the passbook T in the conveying direction.

A control circuit is shown in FIG. 2. Reference numeral 10 denotes a control unit of the printer which is connected to an upper level apparatus (also referred to as a host unit) 20. The control unit 10 is connected with the sensors P0, P1, . . . , P11, the inserter shutter 2, the alignment shutter 3, the dot head 4, and conveying rollers 13a, . . . , 13n and an entrance roller 11 on the conveying path 1. The entrance roller 11 accepts the passbook T inserted in the passbook insert hole 1a and discharges the passbook T, which is completed to be printed by the dot head 4 and is conveyed backward (reversed), out of the passbook insert hole 1a. The conveying rollers 13a, . . . , 13n convey the passbook T forward and backward.

The control unit 10 includes the following means (1) as a main function of conveying and detecting the passbook T.

(1) A control means for generating position information of the passbook T in the conveying path 1 based on the outputs of the sensors P0, P1, . . . , P11 and their mutual relationship. Specifically, the control means generates the position information of the passbook T based not only on the outputs of the sensors P0, P1, . . . , P11 and their mutual relationship, but also on the conveying direction of the conveying path 1, as described below.

The paper sheets detecting device is constituted by the above means (1) of the control unit 10 and the sensors P0, P1, . . . , P11.

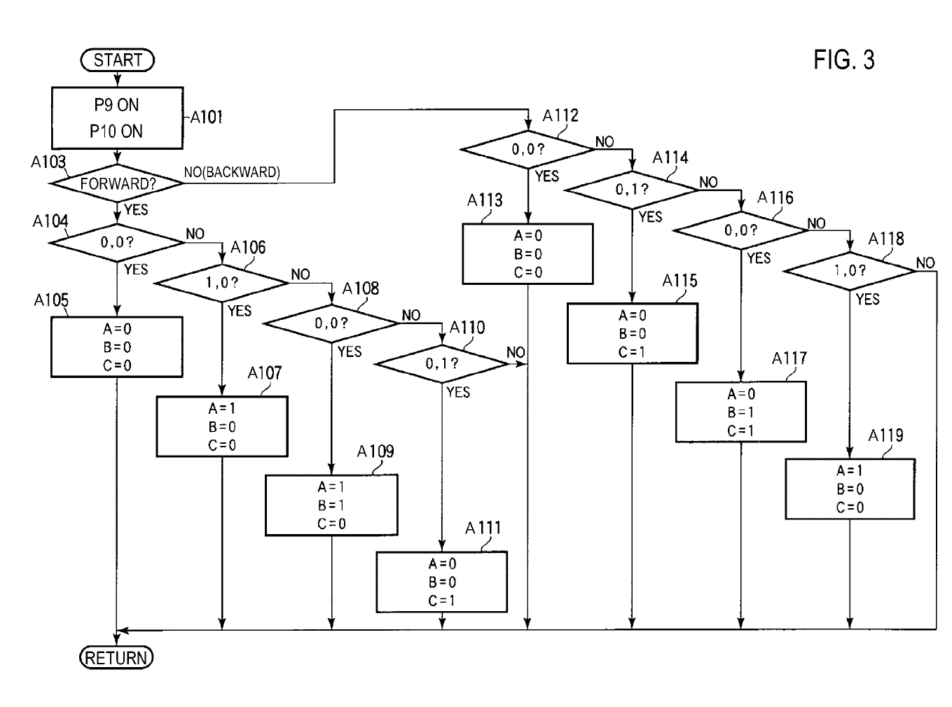

Next, operations according to one embodiment will be described with reference to a flowchart of FIG. 3. First, operation of the sensors P0, P1, . . . , P11, particularly, the sensors P9 and P10 will be described.

When the passbook T is conveyed on the conveying path 1, the sensors P9 and P10 are turned on (Act A101).

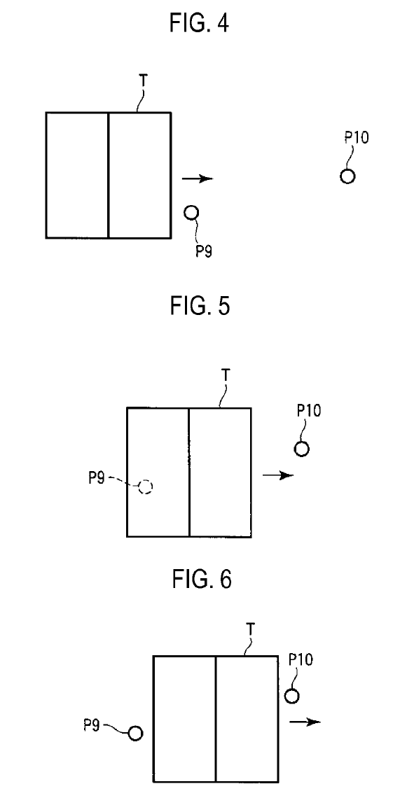

If the conveying direction of the passbook T is the forward direction (YES of act A103) and the passbook T does not cover either of the sensors P9 or P10, as shown in FIG. 4, and if both of output signals from the sensors P9 and P10 are (logic) “0” (YES of act A104), PP9_Status=0 (logic “0”), BetweenP9P10=0 (logic “0”) and PP10Status=0 (logic “0”) are respectively generated as the position information A corresponding to the sensor P9, the position information B corresponding to the middle position between the sensor P9 and the sensor P10 and the position information C corresponding to the sensor P10 (act A105).

Subsequently, if the passbook T covers the sensor P9 but does not yet cover the sensor P10, as shown in FIG. 5, and if an output signal from the sensor P9 is “1” and an output signal from the sensor P10 is “0” (YES of act A106), PP9_Status=1 (logic “1”), BetweenP9P10=0 (logic “0”) and PP10_Status=0 (logic “0”) are respectively generated as the position information A corresponding to the sensor P9, the position information B corresponding to the middle position between the sensor P9 and the sensor P10 and the position information C corresponding to the sensor P10 (act A107).

Subsequently, if the passbook T covers the middle position between the sensor P9 and the sensor P10, as shown in FIG. 6, and if both of output signals from the sensors P9 and P10 are “0” (YES of act A108), PP9_Status=1, BetweenP9P10=1 (logic “1”) and PP10_Status=0 are respectively generated as the position information A corresponding to the sensor P9, the position information B corresponding to the middle position between the sensor P9 and the sensor P10 and the position information C corresponding to the sensor P10 (act A109).

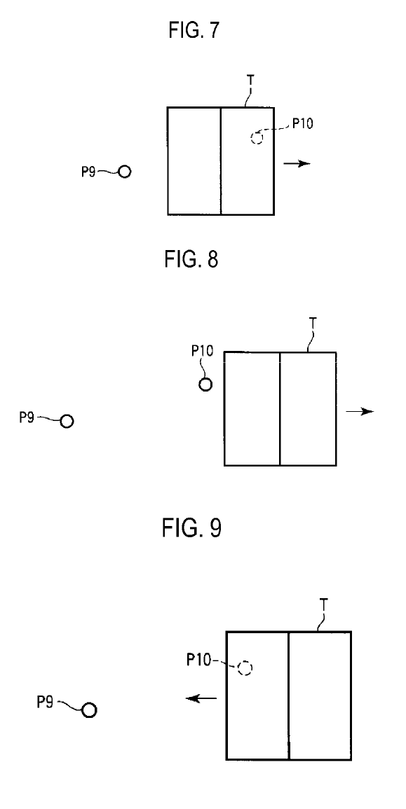

Subsequently, if the passbook T leaves the sensor P9 and covers the sensor P10, as shown in FIG. 7, and if an output signal from the sensor P9 is “0” and an output signal from the sensor P10 is “1” (YES of act A110), PP9_Status=0, BetweenP9P10=0 and PP10_Status=1 are respectively generated as the position information A corresponding to the sensor P9, the position information B corresponding to the middle position between the sensor P9 and the sensor P10 and the position information C corresponding to the sensor P10 (act A111).

Subsequently, if the passbook T passes through the positions of the sensors P9 and P10, as shown in FIG. 8, and if both of output signals from the sensors P9 and P10 are “0” (YES of act A104), PP9_Status=0, BetweenP9P10=0 and PP10_Status=0 are respectively generated as the position information A corresponding to the sensor P9, the position information B corresponding to the middle position between the sensor P9 and the sensor P10 and the position information C corresponding to the sensor P10 (act A105).

In this way, as the passbook T is conveyed in the forward direction, the vacant columns of the passbook T is printed with character information by the dot head 4.

If the printed passbook T is conveyed in the backward direction (NO of act A103) and the passbook T does not cover either of the sensors P9 or P10, as shown in FIG. 8, and if both of output signals from the sensors P9 and P10 are “0” (YES of act A112), PP9_Status=0, BetweenP9P 10=0 and PP10_Status=0 are respectively generated as the position information A corresponding to the sensor P9, the position information B corresponding to the middle position between the sensor P9 and the sensor P10 and the position information C corresponding to the sensor P10 (act A113).

Subsequently, if the passbook T covers the sensor P10 but not does yet cover sensor P9, as shown in FIG. 9, and if an output signal from the sensor P9 is “0” and an output signal from the sensor P10 is “1” (YES of act A114), PP9_Status=0, BetweenP9P10=0 and PP10_Status=1 are respectively generated as the position information A corresponding to the sensor P9, the position information B corresponding to the middle position between the sensor P9 and the sensor P10 and the position information C corresponding to the sensor P10 (act A115).

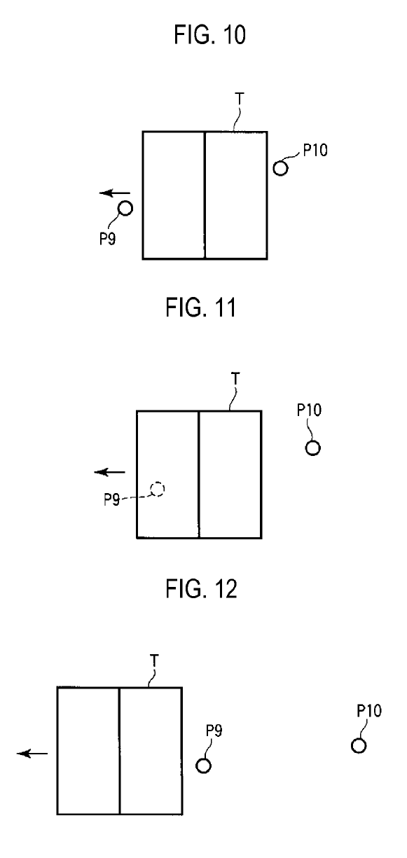

Subsequently, if the passbook T covers the middle position between the sensor P9 and the sensor P10, as shown in FIG. 10, and if both of output signals from the sensors P9 and P10 are “0” (YES of act A116), PP9_Status=0, BetweenP9P10=1 and PP10_Status=1 are respectively generated as the position information A corresponding to the sensor P9, the position information B corresponding to the middle position between the sensor P9 and the sensor P10 and the position information C corresponding to the sensor P10 (act A117).

Subsequently, if the passbook T leaves the sensor P10 and covers the sensor P9, as shown in FIG. 11, and if an output signal from the sensor P9 is “1” and an output signal from the sensor P10 is “0” (YES of act A118), PP9_Status=1, BetweenP9P10=0 and PP10_Status=0 are respectively generated as the position information A corresponding to the sensor P9, the position information B corresponding to the middle position between the sensor P9 and the sensor P10 and the position information C corresponding to the sensor P10 (act A119).

Subsequently, if the passbook T passes through the positions of the sensors P9 and P10, as shown in FIG. 12, and if both of output signals from the sensors P9 and P10 are “0” (YES of act A112), PP9_Status=0, BetweenP9P10=0 and PP10_Status=0 are respectively generated as the position information A corresponding to the sensor P9, the position information B corresponding to the middle position between the sensor P9 and the sensor P10 and the position information C corresponding to the sensor P10 (act A113).

As used in this application, entities for executing the actions can refer to a computer-related entity, either hardware, a combination of hardware and software, software or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS(Operating System) or the like in the apparatus.

The generated position information A, B and C is transmitted to the upper level apparatus 20 at every predetermined transmission time. The upper level apparatus 20 monitors the transmitted position information A, B and C to accurately detect the presence and position of the passbook T.

Particularly, even when the passbook T resides between the sensors P9 and P10, since the position information A (PP9_Status), the position information B (BetweenP9P10) and the position information C (PP10_Status) to represent the presence and position of the passbook T are generated, it is possible to accurately detect the presence and position of the passbook T at all times even if the gap Dp between the sensor P9 and the sensor P10 is set to be longer than the minimum length Dt of the passbook T in the conveying direction.

Since the gap Dp between the sensor P9 and the sensor P10 may be set to be longer than the minimum length Dt of the passbook T in the conveying direction, the number of sensors for passbook detection can be reduced, which may reduce production costs.

Although it has been illustrated in the above embodiment that the gap Dp between the two sensors P9 and P10 is set to be longer than the minimum length Dt of the passbook T, a gap between different sensors may be set in the same way and the number of sensors may be further reduced. In addition, although passbook T has been illustrated as the one example of the paper sheets, other sheets and medium can be conveyed into the printer, without being limited to the passbook T.

While certain embodiments have been described, these embodiments have been presented by way of example only, and are not intended to limit the scope of the inventions. Indeed, the novel devices and apparatuses described herein may be embodied in a variety of other forms; furthermore, various omissions, substitutions and changes in the form of the devices and apparatuses described herein may be made without departing from the spirit of the inventions. The accompanying claims and their equivalents are intended to cover such forms or modifications as would fall within the scope and spirit of the inventions.

What is claimed is:

1. A medium detecting device comprising:
a conveying path configured to convey a plurality of mediums therethrough;
a plurality of sensors configured to detect at least one of the plurality of mediums disposed in a conveying direction of the conveying path, the plurality of sensors being arranged at intervals longer than a minimum length of at least one of the plurality of mediums; and
a control unit configured to generate position information of the plurality of mediums based on output from the plurality of sensors, and the relationship between the sensors.

2. The device of claim 1, wherein the conveying path has a leading end and a tailing end, the conveying path being configured to convey the plurality of mediums in a forward direction extending from the leading end to the tailing end, the conveying path being configured to convey the plurality of mediums in a backward direction extending from the tailing end to the leading end, and
wherein the control unit is configured to generate the position information of the mediums based on output from the plurality of sensors, relationship between the sensors, and conveying direction of the conveying path.

3. The device of claim 2, wherein the plurality of sensors includes at least a first sensor and a second sensor provided from the leading end to the tailing end on the conveying path respectively, the first and second sensors defining a middle position therebetween, and wherein the control unit includes:
a unit for generating a logic “0” as the position information corresponding to the first sensor, a logic “0” as the position information corresponding to the middle position between the first and second sensors, and a logic “0” as the position information corresponding to the second sensor if the plurality of mediums are conveyed in the forward direction and if the plurality of mediums cover one of the first or second sensors;
a unit for generating a logic “1” as the position information corresponding to the first sensor, a logic “0” as the position information corresponding to the middle position between the first and second sensors, and a logic “0” as the position information corresponding to the second sensor if the plurality of mediums are conveyed in the forward direction and if the plurality of mediums cover the first sensor only;
a unit for generating a logic “1” as the position information corresponding to the first sensor, a logic “1” as the position information corresponding to the middle position between the first and second sensors, and a logic “0” as the position information corresponding to the second sensor if the plurality of mediums are conveyed in the forward direction and if the plurality of mediums are moved to the middle position between the first and second sensors;
a unit for generating a logic “0” as the position information corresponding to the first sensor, a logic “0” as the position information corresponding to the middle position between the first and second sensors, and a logic “1” as the position information corresponding to the second sensor if the plurality of mediums are conveyed in the forward direction and if the mediums do not cover the first sensor but cover the second sensor; and
a unit for generating a logic “0” as the position information corresponding to the first sensor, a logic “0” as the position information corresponding to the middle position between the first and second sensors, and a logic “0” as the position information corresponding to the second sensor if the plurality of mediums are conveyed in the forward direction and if the mediums pass through the positions of the first and second sensors.

4. The device of claim 3, wherein the control unit further includes:
a unit for generating a logic “0” as the position information corresponding to the second sensor, a logic “0” as the position information corresponding to the middle position between the first and second sensors, and a logic “0” as the position information corresponding to the first sensor if the plurality of mediums are conveyed in the backward direction and if the mediums do not cover either of the first or second sensors;
a unit for generating a logic “1” as the position information corresponding to the second sensor, a logic “0” as the position information corresponding to the middle position between the first and second sensors, and a logic “0” as the position information corresponding to the first sensor if the plurality of mediums are conveyed in the backward direction and if the mediums cover the second sensor only;
a unit for generating a logic “1” as the position information corresponding to the second sensor, a logic “1” as the position information corresponding to the middle position between the first and second sensors, and a logic “0” as the position information corresponding to the first sensor if the plurality of mediums are conveyed in the backward direction and if the mediums are moved to the middle position between the first and second sensors;
a unit for generating a logic “0” as the position information corresponding to the second sensor, a logic “0” as the position information corresponding to the middle position between the first and second sensors, and a logic “1” as the position information corresponding to the first sensor if the plurality of mediums are conveyed in the backward direction and if the mediums cover the first sensor only; and
a unit for generating a logic “0” as the position information corresponding to the second sensor, a logic “0” as the position information corresponding to the middle position between the first and second sensors, and a logic “0” as the position information corresponding to the first sensor if the plurality of mediums are conveyed in the backward direction and if the mediums pass through the positions of the second and first sensors.

5. A printer comprising:
a conveying path configured to convey a plurality of mediums therethrough;
a plurality of sensors configured to detect at least one of the plurality of mediums disposed in a conveying direction of the conveying path, the plurality of sensors being arranged at intervals longer than a minimum length of at least one of the plurality of mediums;
a control unit configured to generate position information of the plurality of mediums based on output from the plurality of sensors, and the relationship between the sensors; and
a head that prints information on the plurality of mediums.

6. A medium detecting device comprising:
a conveying path configured to convey at least one medium therethrough;
first and second sensors arranged along the conveying path and being configured to detect the at least one medium disposed in a conveying direction of the conveying path, the distance between the first and second sensors being longer than a minimum length of the at least one medium; and
a control unit configured to generate position information of the at least one medium based on output from the first and second sensors, and the relationship between the first and second sensors.

7. The device of claim 6 wherein the conveying path has a leading end and a tailing end, the conveying path being configured to convey the at least one medium in a forward direction extending from the leading end to the tailing end, the conveying path being configured to convey the at least one medium in a backward direction extending from the tailing end to the leading end, and
wherein the control unit is configured to generate the position information of the at least one medium based on output the first and second sensors, relationship between the first and second sensors, and conveying direction of the conveying path.

8. The device of claim 7, wherein the first and second sensors includes are disposed in proximity to the leading end and the tailing end on the conveying path respectively, the first and second sensors defining a middle position therebetween, and wherein the control unit includes:
a unit for generating a logic “0” as the position information corresponding to the first sensor, a logic “0” as the position information corresponding to the middle position between the first and second sensors, and a logic “0” as the position information corresponding to the second sensor if the at least one medium is conveyed in the forward direction and if the at least one medium covers one of the first or second sensors;
a unit for generating a logic “1” as the position information corresponding to the first sensor, a logic “0” as the position information corresponding to the middle position between the first and second sensors, and a logic “0” as the position information corresponding to the second sensor if the at least one medium is conveyed in the forward direction and if the at least one medium covers the first sensor only;
a unit for generating a logic “1” as the position information corresponding to the first sensor, a logic “1” as the position information corresponding to the middle position between the first and second sensors, and a logic “0” as the position information corresponding to the second sensor if the at least one medium is conveyed in the forward direction and if the at least one medium is moved to the middle position between the first and second sensors;
a unit for generating a logic “0” as the position information corresponding to the first sensor, a logic “0” as the position information corresponding to the middle position between the first and second sensors, and a logic “1” as the position information corresponding to the second sensor if the at least one medium is conveyed in the forward direction and if the at least one medium does not cover the first sensor but covers the second sensor; and
a unit for generating a logic “0” as the position information corresponding to the first sensor, a logic “0” as the position information corresponding to the middle position between the first and second sensors, and a logic “0” as the position information corresponding to the second sensor if the at least one medium is conveyed in the forward direction and if the at least one medium passes through the positions of the first and second sensors.

9. The device of claim 8, wherein the control unit further includes:
a unit for generating a logic “0” as the position information corresponding to the second sensor, a logic “0” as the position information corresponding to the middle position between the first and second sensors, and a logic “0” as the position information corresponding to the first sensor if the at least one medium is conveyed in the backward direction and if the at least one medium does not cover either of the first or second sensors;
a unit for generating a logic “1” as the position information corresponding to the second sensor, a logic “0” as the position information corresponding to the middle position between the first and second sensors, and a logic “0” as the position information corresponding to the first sensor if the at least one medium is conveyed in the backward direction and if the at least one medium covers the second sensor only;
a unit for generating a logic “1” as the position information corresponding to the second sensor, a logic “1” as the position information corresponding to the middle position between the first and second sensors, and a logic “0” as the position information corresponding to the first sensor if the at least one medium is conveyed in the backward direction and if the at least one medium is moved to the middle position between the first and second sensors;
a unit for generating a logic “0” as the position information corresponding to the second sensor, a logic “0” as the position information corresponding to the middle position between the first and second sensors, and a logic “1” as the position information corresponding to the first sensor if the at least one medium is conveyed in the backward direction and if the at least one medium covers the first sensor only; and
a unit for generating a logic “0” as the position information corresponding to the second sensor, a logic “0” as the position information corresponding to the middle position between the first and second sensors, and a logic “0” as the position information corresponding to the first sensor if the at least one medium is conveyed in the backward direction and if the at least one medium passes through the positions of the second and first sensors.

10. The device of claim 6 further comprising a head that prints information on the at least one medium.

11. The device of claim 10, wherein the conveying path has a leading end and a tailing end, the conveying path being configured to convey the at least one medium in a forward direction extending from the leading end to the tailing end, the conveying path being configured to convey the at least one medium in a backward direction extending from the tailing end to the leading end, and the head is disposed closer to the tailing end of the conveying path than the leading end thereof.

12. The device of claim 11, wherein an insert hole is defined at the leading end of the conveying path, the insert hole being configured to receive the at least one medium.

13. The device of claim 12, wherein the head is disposed at the tailing end of the conveying path.

14. The device of claim 13, wherein the first and second sensors are provided from the leading end to the tailing end on the conveying path respectively, the first sensor being disposed closer to the insert hole than the second sensor.

15. The device of claim 14, wherein the second sensor is disposed closer to the tailing end than the first sensor.

16. The printer of claim 6, further comprising at least one conveying roller on the conveying path that is configured to convey the mediums in at least one of the forward and backward directions.

17. A medium detecting method comprising:
the act of conveying a plurality of mediums through a conveying path; and
the act of generating position information of the plurality of mediums based on output from a plurality of sensors, and the relationship between the sensors,
the plurality of sensors being configured to detect at least one of a plurality of mediums disposed in a conveying direction of the conveying path, the plurality of sensors being arranged at intervals longer than a minimum length of at least one of the plurality of mediums.

18. The method of claim 17, wherein the conveying path has a leading end and a tailing end, the conveying path being configured to convey the plurality of mediums in a forward direction extending from the leading end to the tailing end, the conveying path being configured to convey the plurality of mediums in a backward direction extending from the tailing end to the leading end, and
wherein generating position information of the plurality of mediums based on output from the plurality of sensors, relationship between the sensors, and conveying direction of the conveying path.

19. The method of claim 18, wherein the plurality of sensors includes at least a first sensor and a second sensor provided from the leading end to the tailing end on the conveying path respectively, the first and second sensors defining a middle position therebetween, and wherein generating position information of the plurality of mediums includes:
the act of generating a logic “0” as the position information corresponding to the first sensor, a logic “0” as the position information corresponding to the middle position between the first and second sensors, and a logic “0” as the position information corresponding to the second sensor if the plurality of mediums are conveyed in the forward direction and if the plurality of mediums cover one of the first or second sensors;
the act of generating a logic “1” as the position information corresponding to the first sensor, a logic “0” as the position information corresponding to the middle position between the first and second sensors, and a logic “0” as the position information corresponding to the second sensor if the plurality of mediums are conveyed in the forward direction and if the plurality of mediums cover the first sensor only;
the act of generating a logic “1” as the position information corresponding to the first sensor, a logic “1” as the position information corresponding to the middle position between the first and second sensors, and a logic “0” as the position information corresponding to the second sensor if the plurality of mediums are conveyed in the forward direction and if the plurality of mediums are moved to the middle position between the first and second sensors;
the act of generating a logic “0” as the position information corresponding to the first sensor, a logic “0” as the position information corresponding to the middle position between the first and second sensors, and a logic “1” as the position information corresponding to the second sensor if the plurality of mediums are conveyed in the forward direction and if the mediums do not cover the first sensor but cover the second sensor; and
the act of generating a logic “0” as the position information corresponding to the first sensor, a logic “0” as the position information corresponding to the middle position between the first and second sensors, and a logic “0” as the position information corresponding to the second sensor if the plurality of mediums are conveyed in the forward direction and if the mediums pass through the positions of the first and second sensors.

20. The method of claim 19, wherein generating position information of the plurality of mediums further includes:
the act of generating a logic “0” as the position information corresponding to the second sensor, a logic “0” as the position information corresponding to the middle position between the first and second sensors, and a logic “0” as the position information corresponding to the first sensor if the plurality of mediums are conveyed in the backward direction and if the mediums do not cover either of the first or second sensors;
the act of generating a logic “1” as the position information corresponding to the second sensor, a logic “0” as the position information corresponding to the middle position between the first and second sensors, and a logic “0” as the position information corresponding to the first sensor if the plurality of mediums are conveyed in the backward direction and if the mediums cover the second sensor only;
the act of generating a logic “1” as the position information corresponding to the second sensor, a logic “1” as the position information corresponding to the middle position between the first and second sensors, and a logic “0” as the position information corresponding to the first sensor if the plurality of mediums are conveyed in the backward direction and if the mediums are moved to the middle position between the first and second sensors;
the act of generating a logic “0” as the position information corresponding to the second sensor, a logic “0” as the position information corresponding to the middle position between the first and second sensors, and a logic “1” as the position information corresponding to the first sensor if the plurality of mediums are conveyed in the backward direction and if the mediums cover the first sensor only; and
the act of generating a logic “0” as the position information corresponding to the second sensor, a logic “0” as the position information corresponding to the middle position between the first and second sensors, and a logic “0” as the position information corresponding to the first sensor if the plurality of mediums are conveyed in the backward direction and if the mediums pass through the positions of the second and first sensors.
